(19) United States
(12) Patent Application Publication
(10) Pub. No.: US 2014/0100959 A1
(43) Pub. Date: Apr. 10, 2014

(54) LOCATION-BASED DIRECTED ADVERTISING SYSTEMS AND RELATED METHODS

(71) Applicants: Vishrut Patel, Roswell, GA (US); Derek Beveridge, Cumming, GA (US); Thomas Pfeffer, Ball Ground, GA (US)

(72) Inventors: Vishrut Patel, Roswell, GA (US); Derek Beveridge, Cumming, GA (US); Thomas Pfeffer, Ball Ground, GA (US)

(21) Appl. No.: 13/644,588

(22) Filed: Oct. 4, 2012

(51) Int. Cl. G06Q 30/02

(52) U.S. Cl. 705/14.58; 705/14.49

(57) ABSTRACT

Location-based directed advertisement systems, according to particular embodiments, direct merchant-created advertisements to users when those advertisements meet the user's shopping preferences. The user's shopping preferences may include, for example, preferences to receive advertisements for particular items or classes of items, preferences to receive advertisements from particular stores or types of stores, and preferences to receive advertisements for items that are geographically close to the user's location. In particular embodiments, merchants can limit the recipients of the merchant's created advertisements to particular groups of users such as users of a certain age, gender, or occupation. In various embodiments, merchants can view consumer demand data in order to tailor offers to maximize profits, potential unit sales, etc.

### BACKGROUND

Advertising and marketing play an important role in facilitating the sale of products and services to customers. Customers desire to receive advertisements for products and services that interest them, but typically don't wish to receive advertisements for products or services that they don't want or need. On the other side of the advertising spectrum, merchants typically wish to target advertisements to the customers who would most likely be receptive to their advertising. Current advertising methods are often overly inclusive and expensive. Accordingly, there is a need for new and unique advertising systems and methods that better match offers to existing demand in the market.

### SUMMARY OF VARIOUS EMBODIMENTS

A non-transitory computer-readable medium, according to a particular embodiments, stores computer-executable instructions for: (A) receiving, from one or more users, at least one desired product or service and at least one desired price associated with said at least one desired product or service; (B) displaying the at least one desired product or service and the at least one desired price associated with the at least one desired product or service to one or more merchants; (C) receiving an offer price for the particular product or service from the one or more merchants; (D) determining which of the at least one desired prices are greater than or equal to the one or more offer prices; and (E) at least partially in response to determining which of the at least one desired prices are greater than or equal to the one or more offer prices, directing an offer for the particular product or service at the offer price to each of the one or more users associated with the at least one desired price.

Location-based directed advertisement systems, in particular embodiments, comprise at least one computer process and member. In various embodiments, the location-based directed advertisement system is configured for: (A) receiving, from at least one user, at least one user shopping preference, the user shopping preference comprising at least a desired price associated with a particular product or service; (B) receiving, from at least one merchant, at least one offer; (C) determining whether the at least one offer satisfies the at least one user shopping preference; (D) receiving a location associated with the at least one user; (E) determining whether the location is no more than a particular distance from a physical location associated with the merchant; and (F) in response to determining that the at least one offer satisfies the at least one user shopping preference and that the location is no more than the particular distance from the physical location associated with the merchant, displaying the at least one offer to the at least one user.

A directed advertisement system, according to a particular embodiment, comprises at least one computer processor and memory. In various embodiments the directed advertisement system is configure for: (A) receiving at least one desired product or service and a desired price associated with the at least one desired product or service from at least one user; (B) displaying the desired price associated with the at least one desired product or service for each of the at least one user to a merchant; (C) allowing the merchant to direct an offer to each of the at least one user whose the desired price for the at least one desired product or service is greater than or equal to an offer price; and (D) at least partially in response to allowing the merchant to direct the offer, displaying the offer and the offer price to each of the at least one user whose the desired price for the at least one desired product or service is greater than or equal to the offer price.

### BRIEF DESCRIPTION OF THE DRAWINGS

Having thus described various embodiments in general terms, reference will now be made to the accompanying drawings, which are not necessarily drawn to scale, and wherein:

FIG. 1 is a block diagram of a Directed Advertising System according to one embodiment.

FIG. 2 is a block diagram of an Advertisement Server of FIG. 1.

FIG. 3 depicts a flowchart that generally illustrates the operation of an Advertisement Module according to a particular embodiment.

FIGS. 4-8 are screen displays according to a particular embodiment showing an exemplary user interface via which a user can access the system.

FIGS. 9-12 are screen displays according to a particular embodiment showing an exemplary user interface via which a user merchant can access the system.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Overview

Computer systems according to various embodiments are adapted to: (1) obtain specific shopping preferences from consumers; (2) obtain advertisements and/or merchant criteria from one or more merchants; and (3) use the shopping preferences, merchant criteria, and the content of the advertisements to distribute advertisements to the consumers based on the consumers' respective shopping preferences. In various embodiments, the consumers' shopping preferences may be specific. For example, the preferences may specify that a particular consumer wishes to purchase a particular product at or below a particular price from a store (e.g., any store) that is within a certain distance of the customer's home or current location. In various embodiments, the system is configured to search a database for advertisements that include product or service offers that satisfy the customer's specified shopping preferences. The system may then distribute any such advertisements to the customer.

In certain embodiments, the system may only distribute the advertisements to the customer if doing so would satisfy one or more merchant criteria specified by the merchant. For example, if the merchant only wishes to distribute advertisements to women who are between 20 and 25 years old, the system would only distribute the advertisements to such women who have specific shopping preferences that would be satisfied by the advertisements.

In particular embodiments, the system may make merchants aware of consumers' preferences and allow the merchants to optionally tailor their offers/advertisements to satisfy the customers' preferences. As a particular example, the system may notify a particular hardware store that 100 customers within a 5 mile radius of the hardware store desire to purchase a “green egg” barbeque grill for $550. In response to receiving this information, the hardware store may decide to offer the specified barbeque grill for $550, or for a slightly higher price. The system may then distribute the offer to the 100 customers for their consideration. Various embodiments are discussed in greater detail below.

User Shopping Preferences

As noted above, systems according to various embodiments are configured to allow users to enter various shopping preferences that express their demand for particular products or services. In particular embodiments, the user's particular shopping preferences may include, for example, a preference to receive advertising offers from a general group of merchants or from a specific merchant. A user may, for example, provide a shopping preference to receive advertisements from general groups of merchants such as hardware stores, grocery stores, consumer electronics stores, sporting goods stores, book stores, or any other suitable group or type of merchant. Merchants, as used in this application, should be understood to include sellers of merchandise, as well as providers of services and other goods. In various embodiments, a user providing a shopping preference to receive offers only from grocery stores would not, for example, receive advertising offers from hardware stores.

In particular embodiments, the system may be configured to allow users to provide shopping preferences indicating a desire to receive advertisements or offers for, for example, a particular category of items or services or a particular item or service. Particular categories of items or services may include, for example, any suitable general category of item such as televisions, cleaning services, books, shoes, etc. A particular item or service which a user may include as a shopping preference may include, for example, any suitable specific item or service such as a Magnavox 42 inch plasma television, a residential carpet cleaning service, J. K Rowling's novel Harry Potter and the Order of the Phoenix, a pair of Walnut Allen Edmonds' Strands in size 11, etc.

In various embodiments, in addition to allowing users to provide preferences for categories of items and services or specific items and services, the system may be adapted to allow users to provide a price range at which they would be willing to receive advertisements for such items or services. For example, a user may provide a shopping preference to receive offers for a particular product below a particular price (e.g., a 42 inch LCD television for less than $1,200).

In particular embodiments, the system may be configured to allow users to specify a shopping preference for particular geographical locations. For example, the user may specify a shopping preference to only receive advertising offers from merchants with physical locations in a particular city, a particular postal code, a particular neighborhood, a particular shopping center, a particular mall, or any other suitable location or area. In various embodiments, the user specifies a desire to only receive advertising offers from merchants with physical store locations within a particular distance of the user's current location (e.g., which the system may determine based at least in part on a geo-location of the user that is acquired using the GPS functionality of a mobile device associated with the user (e.g., a GPS enabled smart phone), or known triangulation techniques. For example, a user may provide a shopping preference to receive offers for stores within a 5 mile radius of the user's current location (which will change as they move from place to place). In other embodiments, the system receives a shopping preference of the user that limits the geographical area from which the system directs advertisements to those geographical areas within a certain distance of the user's home.

Advertisements

In particular embodiments, merchants create advertisements which may include, for example, one or more offers to sell items at a particular price. For example, an advertisement may cover specific items or services, general categories of items or services, or any item or service that the merchant sells or provides. For example, the merchant may: (1) create an advertisement that includes an offer to sell a particular new, 42 inch plasma television for $899; (2) an coupon for 10% off of all televisions; or (3) a coupon for 10% off all items in the merchant's store.

In various embodiments, the system may communicate the user's shopping preferences to one or more merchants accessing the system, and the appropriate merchants may in turn tailor their created advertisements to meet the user's shopping preferences. In particular embodiments, the merchants may use the system to “push” such advertisements to particular users, or particular groups of users. In various embodiments, merchants may associate merchant preferences with the created advertisements, which may serve to define the type of users to whom the created advertisements may be sent (e.g., the system may be configured to only send advertisements to users who satisfy certain criteria—even if the advertisement would satisfy the users' shopping preferences.

As a particular example, a merchant may create an advertisement for 10% off of a plasma television for males between the ages of 18 and 35 during the week leading up to the Superbowl. In particular embodiments, the system would only send the advertisement to users who are male and between the ages of 18 and 35, and whose shopping preferences indicate a desire for a plasma television within (or close to) the specified price range.

Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

Exemplary System Architecture

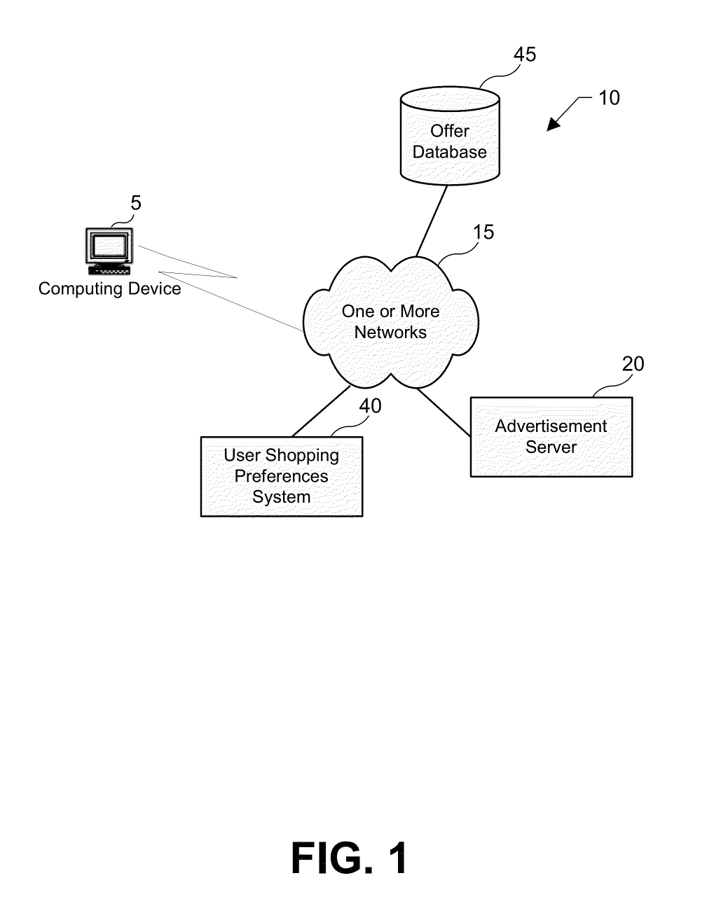

FIG. 1 shows a block diagram of a Directed Advertisement System 10 according to a preferred embodiment of the present invention. As may be understood from this figure, the Directed Advertisement System 10 includes at least one computing device 5 (which may include, for example, a tablet, computer, handheld device, smart phone, or laptop), one or more computer networks 15, an Advertisement Server 20, a User Shopping Preferences System 40, and an Offer Database 45. The one or more computer networks 15 facilitate communication between the computing device 5, Advertisement Server 20, User Shopping Preferences System 40, and Offer Database 45. These one or more computer networks 15 may include any of a variety of types of computer networks such as the Internet, a private intranet, a public switch telephone network (PSTN), or any other type of network known in the art. In certain variations of the embodiment shown in FIG. 1, both the communication link between the computing device 5, Advertisement Server 20, User Shopping Preferences System 40, and Offer Database 45 are implemented via the Internet using Internet protocol (IP). The communication link between the Advertisement Server 20 and the Offer Database 45 may be, for example, implemented via a Local Area Network (LAN).

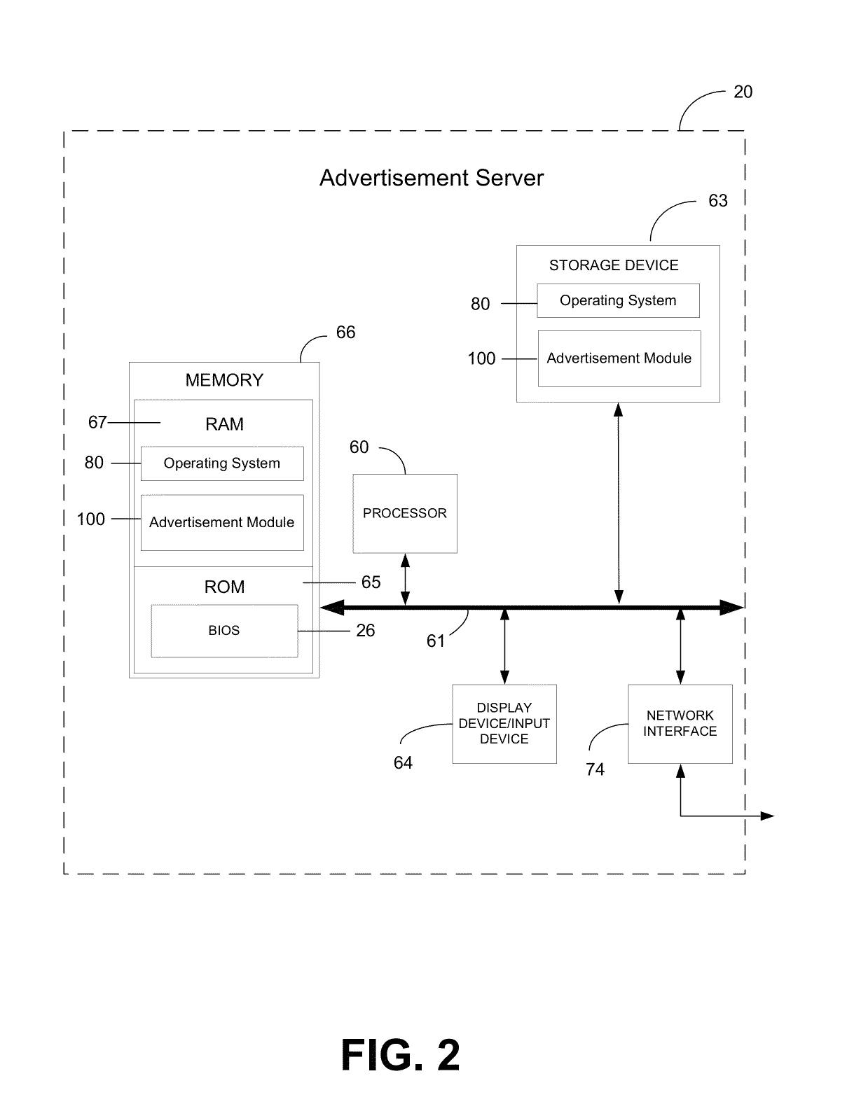

FIG. 2 shows a block diagram of an exemplary embodiment of the Advertisement Server 20 of FIG. 1. The Advertisement Server 20 includes a processor 60 that communicates with other elements within the Advertisement Server 20 via a system interface or bus 61. Also included in the Advertisement Server 20 is a display device/input device 64 for receiving and displaying data. This display device/input device 64 may be, for example, a keyboard, voice recognition, or pointing device that is used in combination with a monitor. The Advertisement Server 20 further includes memory 66, which preferably includes both read only memory (ROM) 65 and random access memory (RAM) 67. The server's ROM 65 is used to store a basic input/output system 26 (BIOS) that contains the basic routines that help to transfer information between elements within the Advertisement Server 20.

In addition, the Advertisement Server 20 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for the Advertisement Server 20. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80 and an Advertisement Module 100. The Advertisement Module 100 controls certain aspects of the operation of the Advertisement Server 20, as is described in more detail below, with the assistance of the processor 60 and an operating system 80.

Also located within the Advertisement Server 20 is a network interface 74 for interfacing and communicating with other elements of a computer network. It will be appreciated by one of ordinary skill in the art that one or more of the Advertisement Server 20 components may be located geographically remotely from other Advertisement Server 20 components. Furthermore, one or more of the components may be combined, and additional components performing functions described herein may be included in the Advertisement Server 20.

### Exemplary System Modules

As noted above, various aspects of the system's functionality may be executed by certain system modules, including the system's Advertisement Module 100. This module is described in greater detail below.

Advertisement Module

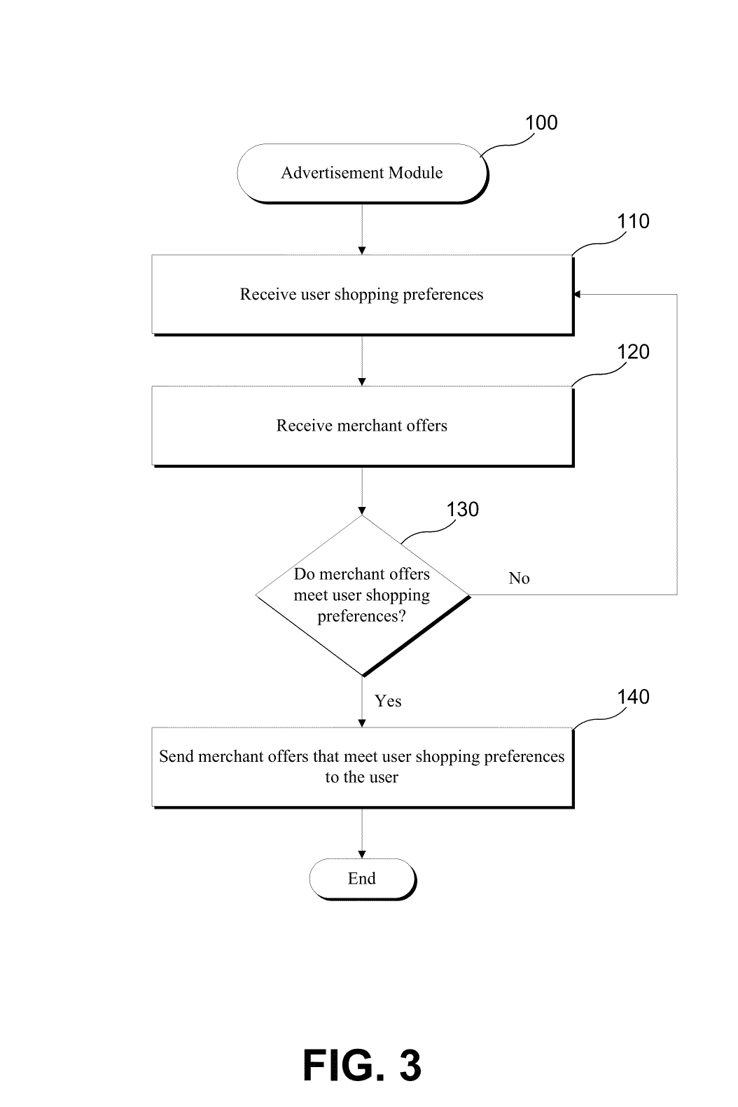

FIG. 3 is a flow chart of an exemplary Advertisement Module 100. As may be understood from FIG. 3, certain embodiments of an Advertisement Module 100 are configured to provide advertising offers for users that meet a user's shopping preferences. For example, a user may have shopping preferences that include finding a 42 inch plasma television for less than $900. An advertising Module 100 may be adapted to provide such a user with advertising offers for 42 inch plasma televisions that are priced below $900.

Beginning at Step 110, the system receives user shopping preferences. User shopping preferences may include, for example, preferences to receive advertising information for a particular geographical area or location, particular stores, and/or for particular items. The system may receive user shopping preferences via any suitable computing device (e.g., a smart phone, tablet, or desktop computer), for example, from direct user input via a keyboard, through oral input by the user via voice recognition, or in any other suitable manner.

In a particular embodiment, the system receives shopping preferences for a particular item when the user scans a bar code associated with the item (e.g., by directing a camera associated with the user's mobile device at the item's bar code). A user may, for example, see an item the user wishes to purchase when at a store (e.g., a Blu Ray player) that has a price that is greater than the user may willing to pay for the item. The user may scan the item's bar code with their mobile device and send the bar code to the system. In response to receiving the bar code, in particular embodiments, the system retrieves information associated with the bar code and adds the item to the user's shopping preferences. In particular embodiments, the system receives shopping preferences of a particular price range for a particular item for which the user wishes to receive offers (e.g., a preference for a 42 inch television for between $500 and $1,000).

The system then receives, at Step 120, merchant advertising offers. Merchant advertising offers may include, for example, advertisements that include discount prices on featured items that the merchant wishes to advertise. In particular embodiments, merchant advertising offers also include merchant preferences such as a particular age group that the advertisement may be directed towards, a particular gender of customer that the advertisement may be directed towards, a preference requiring a user to have a particular occupation in order to receive the advertisement, a preference that a user must be within a particular distance of a physical location associated with the merchant in order to receive the advertisement, etc. In various embodiments, a merchant advertising offer includes a time period for which the offer is available (e.g., only on weekdays or between April 10^{th} and April 13^{th}). Merchant advertising offers may also limit the number of people who may redeem a particular offer (e.g., the offers may limit the number of people who can redeem an offer for a $159 washing machine to the first ten customers who accept the offer).

Returning to FIG. 3, the system determines, at Step 130, whether an advertising offer received at Step 110 falls within (or within a certain tolerance of) the user shopping preferences received at Step 110. For example, an offer for a 42 inch plasma television for $769 would fall within a user shopping preference of wanting a 42 inch plasma television for less than $800. If the system determines, at Step 130, that the advertising offer does not fall within a user shopping preference, the system returns to Step 110. However, if the system determines at Step 130 that the advertising offer does fall within one of the user's defined shopping preferences, the system continues to Step 140, where the system sends the merchant advertising offer to the user whose shopping preference was met by the offer. In embodiments where the offer includes merchant preferences, the system, before displaying an offer that meets a particular user's shopping preferences to the user, additionally determines whether the user meets the merchant preferences. In such embodiments, after determining that the user meets the merchant preferences, the system displays the offer to the user.

In various embodiments, the system is configured to display offers to the user via ‘push notifications’ to a mobile device associated with the user. In other embodiments, the system is configured to send offers to the user via e-mail or make the offers available to the user via a web interface (e.g., through an account associated with the user).

### Exemplary User Experience

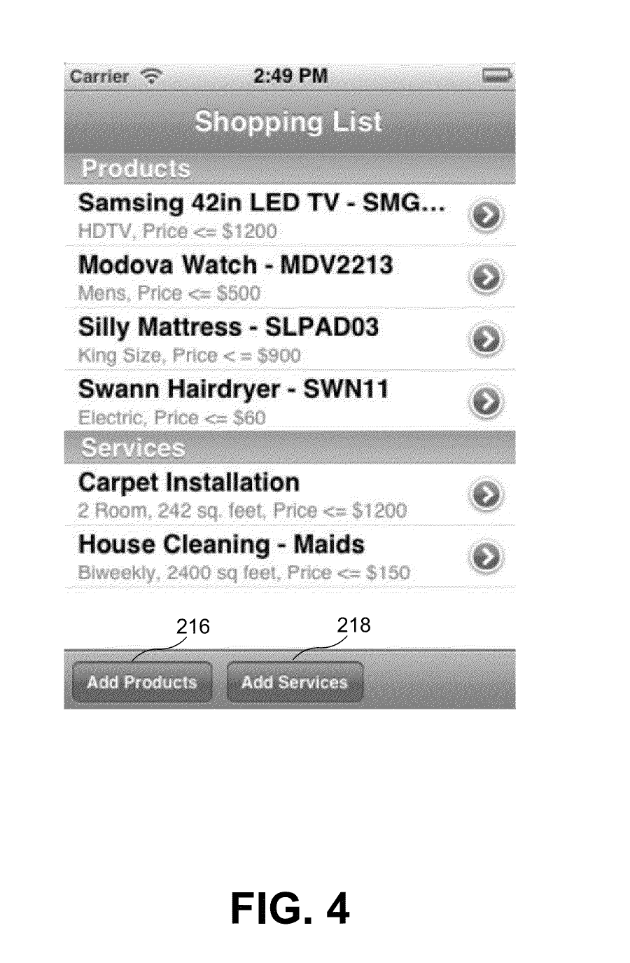

An exemplary user interface for a particular embodiment of a Directed Advertisement System 10 is shown in FIGS. 4-8. These figures represent interfaces displayed on tablet computers, desktop computers, laptops, handheld devices such as smart phones, and other similar devices. These interfaces may be used by users to access the system.

As may be understood from FIGS. 4-8, a user may set their shopping preferences by accessing a user interface. To begin setting their shopping preferences, a user may login to the shopping preference system (e.g., using a suitable computing device such as a smartphone, tablet computer, or laptop) using an on-screen user interface. In particular embodiments, logging into the shopping preference system requires a user to enter user information such as a user name or password. In other embodiments, a user interface includes other login methods such as biometric scanners (e.g., finger print scanners) or any other suitable login method.

In various embodiments, the user interface includes interfaces that allow a user to specify the user's shopping preferences via store choices, shopping lists, and personal preferences, such as those discussed above. As shown in FIG. 4, a user may create a shopping list by pressing buttons to Add Products 216 and Add Services 218. A user may press the Add Products 216 button to add a particular item or class of items for which the user wishes to receive advertisements and offers. For example, a user may press the Add Products button 216 to add an item to their shopping list such as a Blu-ray player. The user may then also press the Add Services button 218 if the user wishes to add particular services for which they would like to receive offers as well (e.g., cleaning services, auto services, etc.).

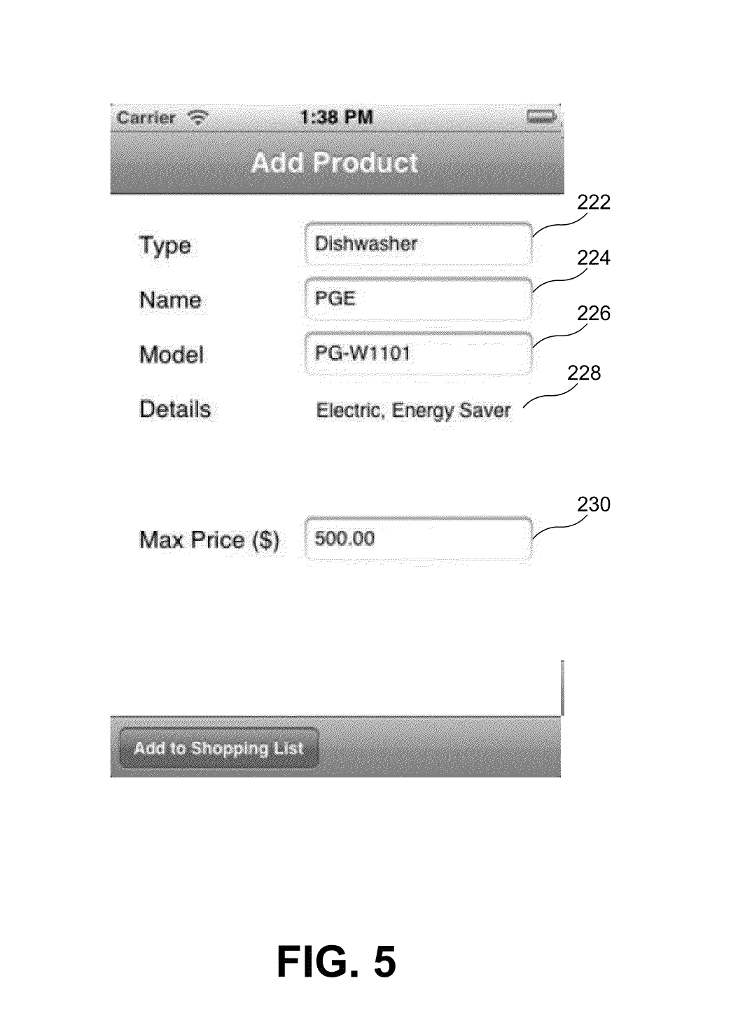

FIG. 5 shows an exemplary interface that a user may use to enter information for new products to add to their shopping list. As shown in this figure, a user may enter a type 222, name 224, model 226, details 228, and a maximum price 230 for a product for which the user wishes to receive offers. For example, the user may enter specific information for a dishwasher that the user wishes to purchase, such as the name of the dishwasher (e.g., PGE), the model of the dishwasher (e.g., PG-W1101), details regarding the dishwasher (e.g., that the dishwasher is electric and energy saving), and a maximum desired price the user is willing to pay for the dishwasher (e.g., $500).

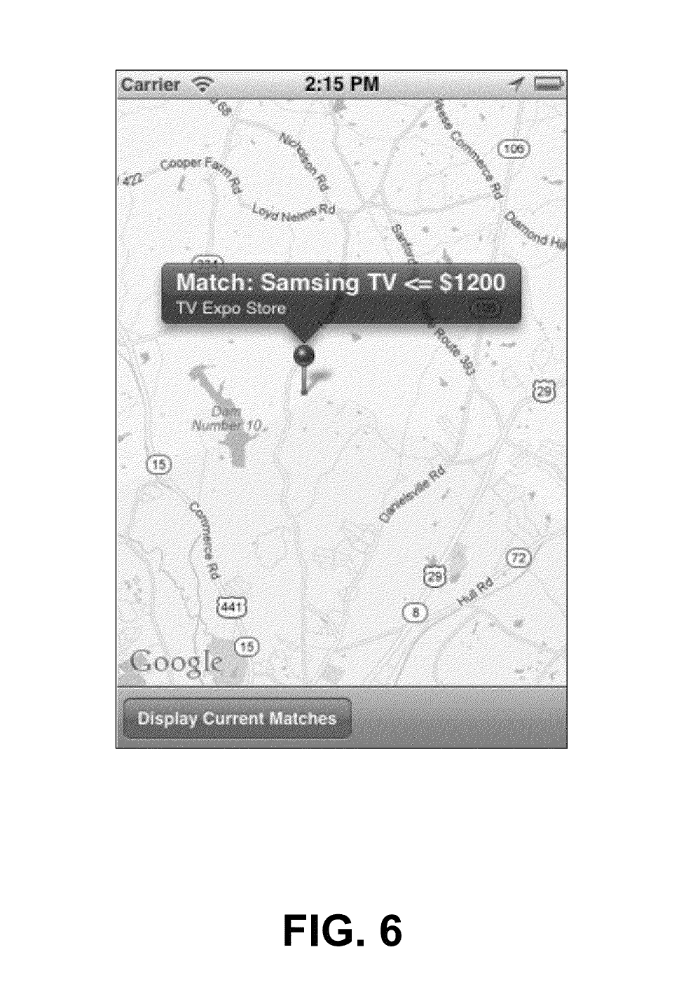

FIG. 6 shows an exemplary screen display showing the location on a map of a product that matches an item on a user's shopping list. For example, in this figure, a Samsung Television for less than $1200.00 is shown on the map at a store called TV Expo Store. In various embodiments, the system is configured to display directions to the location where the product is available at the user's preferred price.

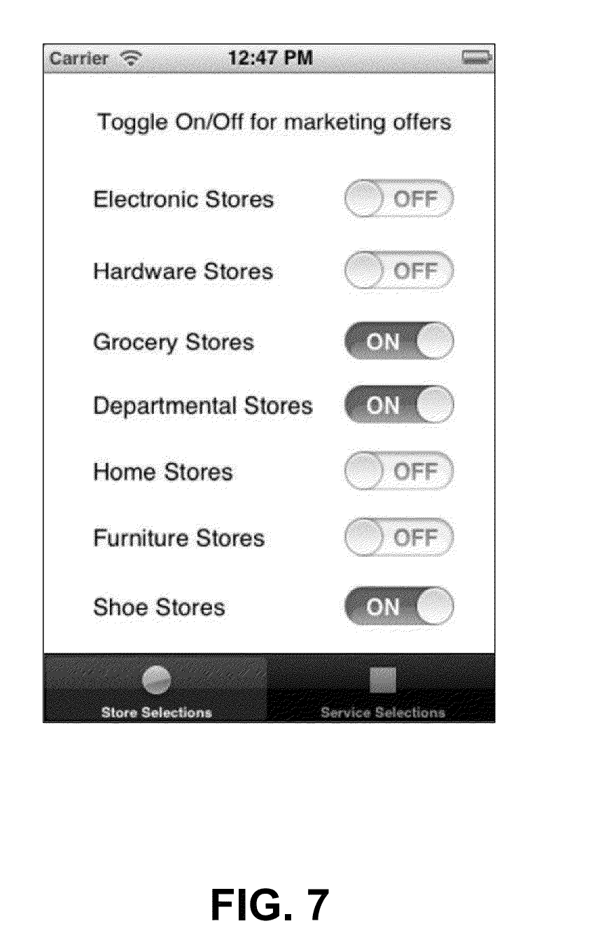

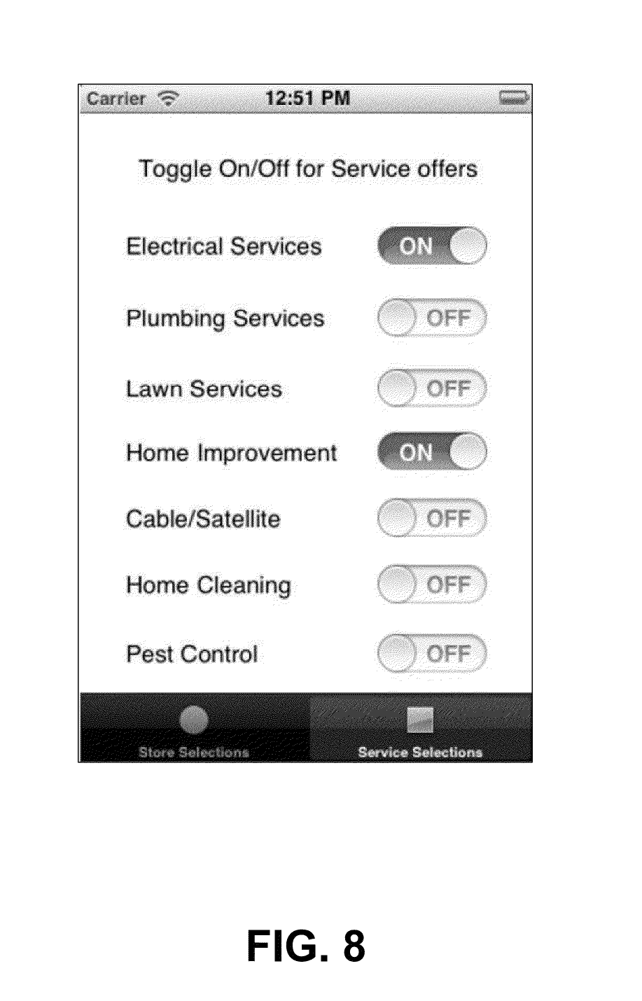

As shown in FIGS. 7 and 8, users may toggle marketing or service offers based on what sort of general offers the user wishes to receive. For example, users may toggle an on/off switch to turn on or turn off offers from particular store groups (e.g., electronic stores, hardware stores, grocery stores, etc.). Users may further select whether they desire to receive offers for services (e.g., electrical services, plumbing services, lawn services, etc.).

In various embodiments, a user may set personal preferences regarding what offers they would like to receive. A user may, for example, set a maximum distance from the user's current location in which the user would like to receive offers. For example, a user may limit advertisements they receive to offers from businesses that are within a five mile radius of the user's current location (e.g., which may be determined, for example, from geographical data obtained from a mobile device associated with the user, or any other suitable method). A user may further enable or disable pop up notifications of offers. The user may wish, for example, to receive push notifications or pop up notifications on their mobile device when a new offer becomes available that meets the user's shopping preferences. The user may also set the frequency with which they wish to receive new offers that meet the user's shopping preferences. The user may, for example, set a preference to receive any offers that meet their shopping preferences once every hour or once per day at a particular time (e.g., every morning at 8 AM).

### Exemplary Merchant Experience

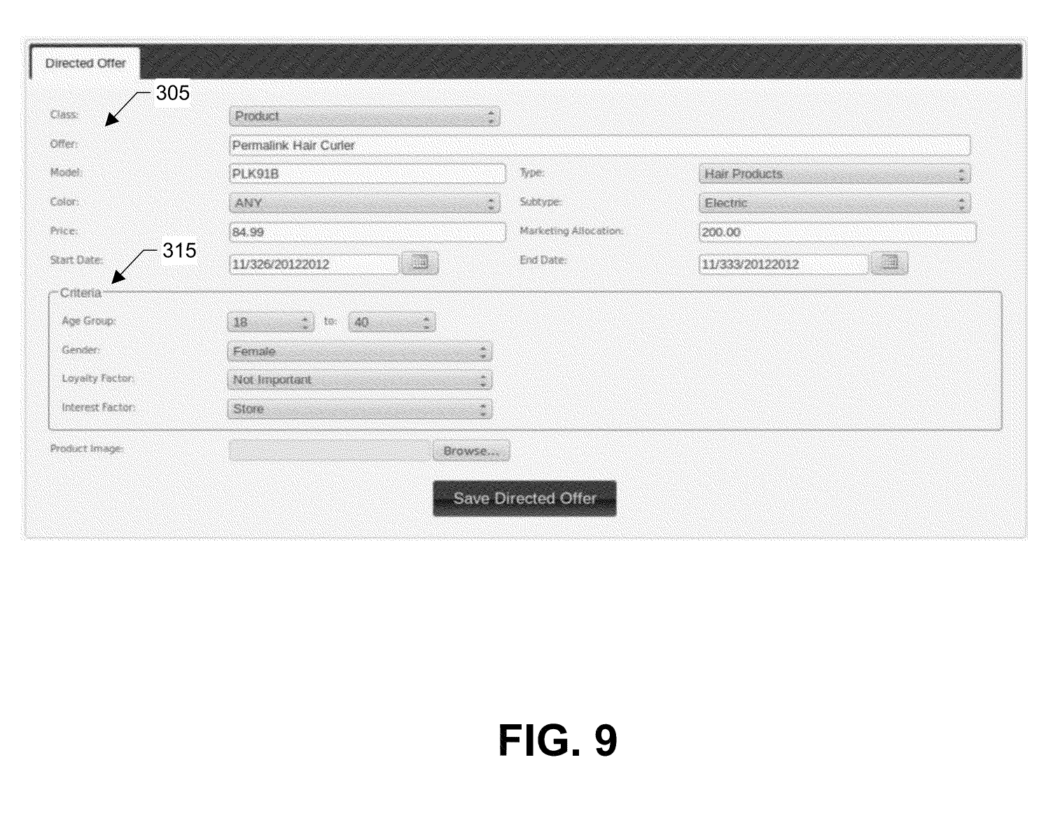

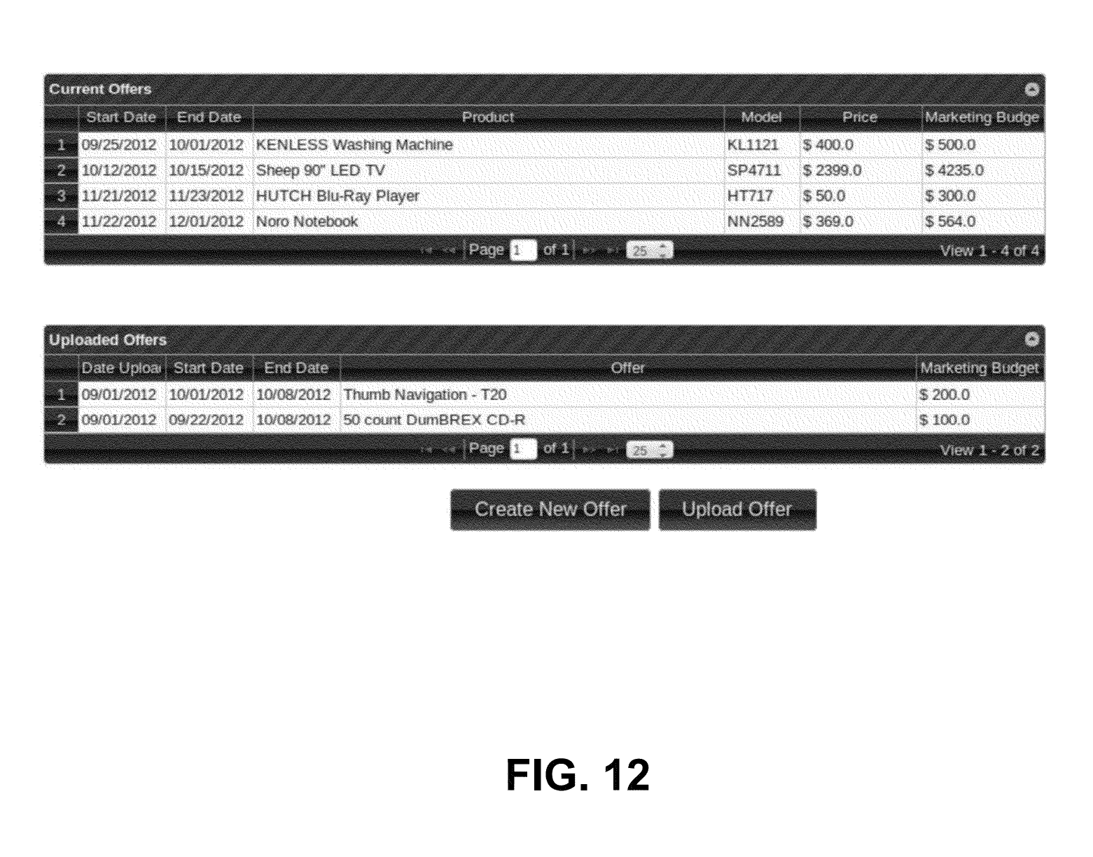

An exemplary interface that a merchant may use to access the system is shown in FIGS. 9-12. To access a merchant interface, a merchant may login to the system (e.g., using a suitable computing device such as a smartphone, tablet computer, or laptop) using an on-screen interface. Logging into the advertisement system may require a merchant to enter user information such as a user name or password or merchant information such as the name of a business.

FIGS. 9-12 show exemplary interfaces for use by merchants to create advertisements, view current offerings that the merchant has made, and manage accounts. FIG. 9 shows an exemplary interface that allows a merchant to create advertisements. As may be understood from this figure, a merchant may create directed offers for users who meet particular criteria. These directed offers may, for example, include product information 305 as well criteria 315 which define which users to whom the offer may be directed. The product information 305 may include, for example, a description of the offered product (e.g., Permalink Hair Curler), a model number of the offered product (e.g., PLK91B), a type of the product (e.g., hair product), a price (e.g., $84.99), a marketing allocation (e.g., an amount of money the merchant is willing to spend to send the directed offer), and start and end dates (e.g., a date range during which the product will be available at the particular price). The interface may also allow a merchant to enter criteria 315 that users of the system must meet to receive the directed offer. Criteria 315 that the user may set may include, for example, an age group (e.g., 18 to 40), a gender (e.g., male, female, or both), a loyalty factor (e.g., a particular number of times that the user has shopped with the merchant making the directed offer), and an interest factor (e.g., whether the user has expressed a desire to receive offers from the merchant or stores similar to the merchant). An advertisement for a 42 inch television before the Super bowl, for example, may be targeted towards males between the ages of 18 and 37.

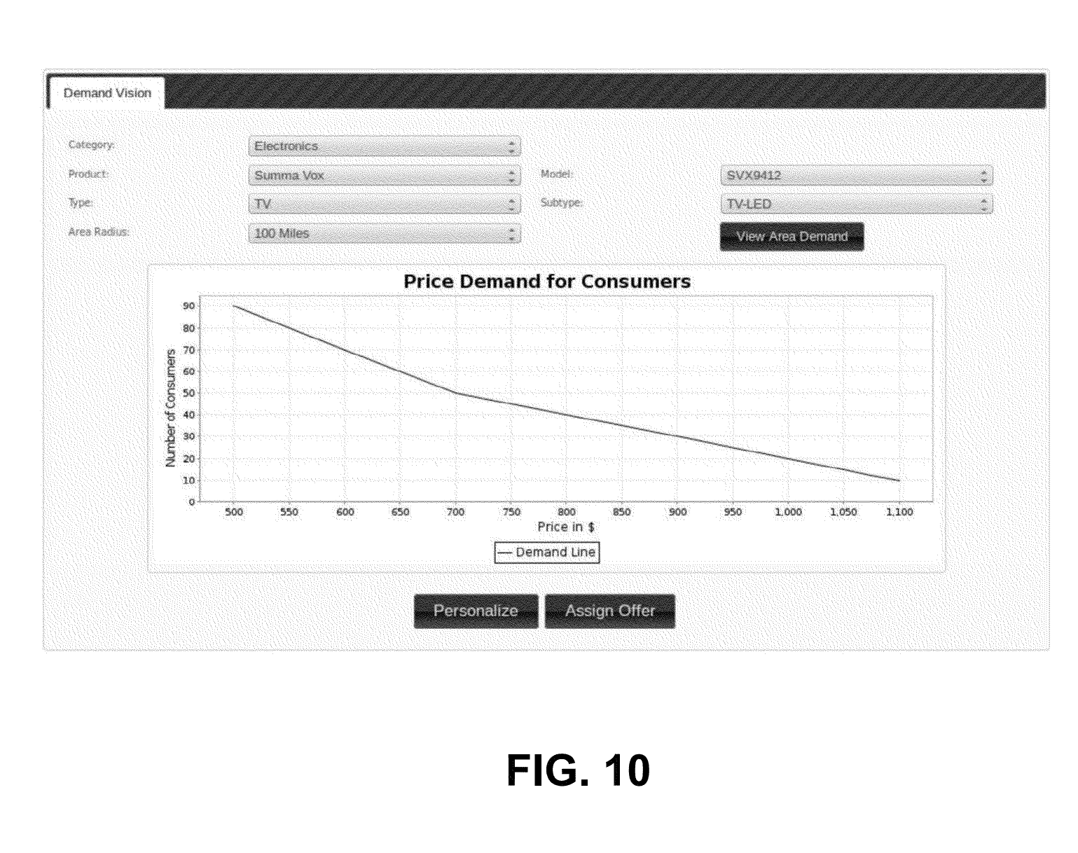

As may be understood from FIG. 10, in various embodiments, merchants may view consumer demand for particular goods or services via a Price Demand for Consumers interface. As shown in this figure, merchants may view a graphical representation of the number of consumers that have indicated an interest for a particular product at particular price points. In the example shown in this figure, consumer demand for a Summa Vox television, with model number SVX9412 is displayed on a graph indicating how many consumers have entered a shopping preference to purchase the television at various prices. In various embodiments, merchants may utilize this consumer demand data when creating offers (e.g., directed offers) for particular products. For example, if a merchant can see that 15 consumers have indicated a desire to purchase a particular television for $1,025, and that merchant has 15 of that particular television in stock, the merchant may direct offers for that television to those 15 consumers (e.g., or all consumers) for the television at a price of $1,025.

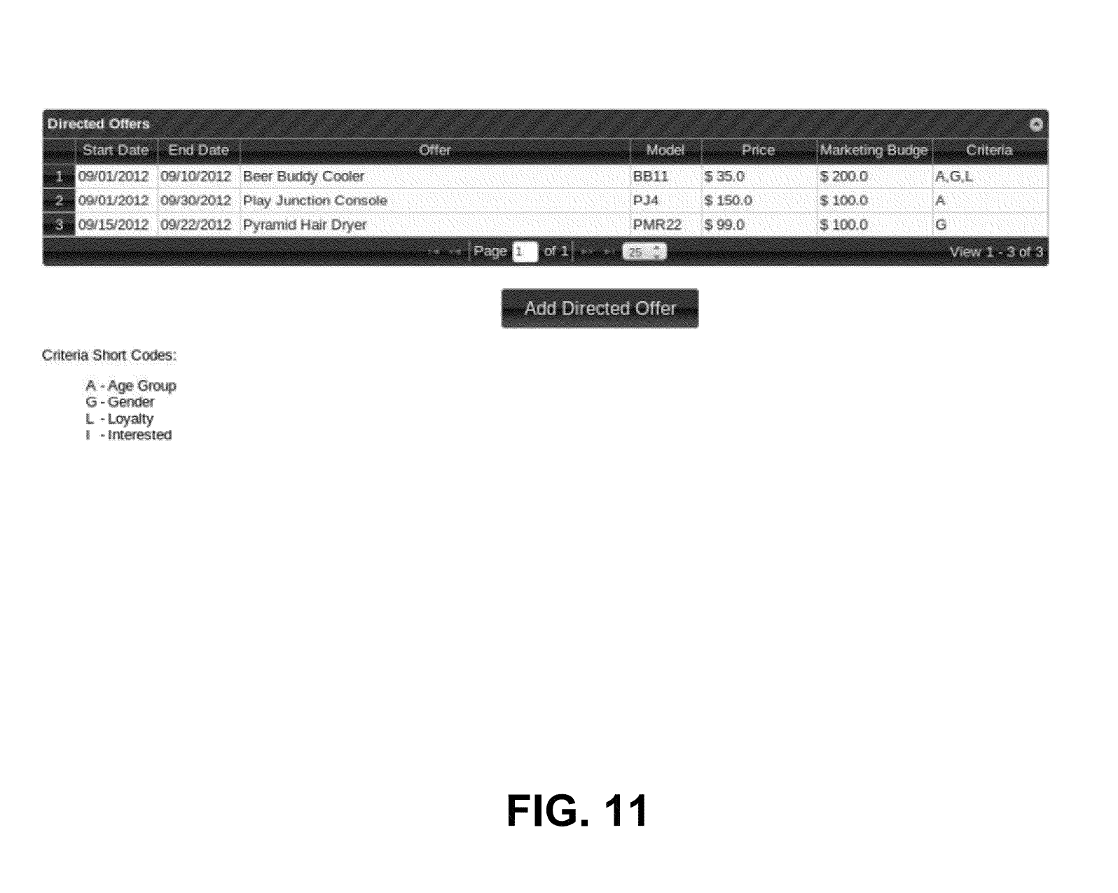

In various embodiments, as shown in FIGS. 11 and, merchants can view offers they are currently running via a list of Directed Offers, Current Offers, and Uploaded Offers. In various embodiments, merchants may also have the ability to edit or delete offers that they no longer wish to run. A merchant may, for example, adjust the price of an advertised Beer Buddy Cooler from $35.00 to $32.50. In various embodiments, the ability to view all current ad offerings and the associated details may be helpful for merchants that run a large number of advertisements at one time.

In various embodiments, the system is configured to allow a merchant to manage the merchant's account online. A merchant may, for example, be able to change their billing information including how the merchant is billed for the distribution of their ads. In particular embodiments, the system charges merchants for the service of distributing advertisements in any suitable manner. For example, the system may charge a fee to the merchant for every user that receives their advertisement (e.g., every user for whom the merchant's created advertisements fit the user's shopping preferences). Merchants may be able to allocate a certain budget to their advertisement distribution via a marketing dollar allocation option. A merchant may, for example, limit a monthly marketing budget to $500. Merchants may also access analysis of ad Usage that may include information regarding usage analysis of particular advertised offerings. Such information may include, for example, the number of users who utilize a particular advertised offer. In various embodiments, merchants may also be able to view statistics related to historical ad or deal usage. Other statistical information that the merchant may access may include, for example, amount of sales generated from their advertising efforts, return on their advertisement investment, and any other information that a merchant may desire to learn concerning their use of the advertisement system.

### First Illustrative Example

In a particular illustrative example, a user may desire to purchase a new iPhone 4s for less than $150. Such a user may access the Directed Advertising System via their current smart phone, computer, tablet, or other suitable device. The user may then, at Step 110 provide the shopping preferences to the system of desiring an iPhone 4s for less than $150. The user may provide further shopping preferences such as wanting to find the phone at a store within 5 miles of the user's home.

The system may then receive merchant offers at Step 120. As the system receives merchant offers, the system determines, at Step 130, whether the merchant offers fall within the user's shopping preferences of purchasing an iPhone 4S for under $150 within 5 miles of the user's home. A merchant offer for an iPhone 4S for $149 at a store 9 miles from the user's home would not meet the user's shopping preferences. An iPhone 4S for $149 at a store 2 miles from the user's home, however, would meet the user's shopping preferences. If a merchant were offering an iPhone 4s for $149 at a store 2 miles from the user's home, the system would send the offer to the user at Step 140.

### Second Illustrative Example

In a particular illustrative example, a merchant may desire to place an offer on a particular 42 inch plasma television. In various embodiments, the merchant may be able to analyze customer demand data in order to create an offer that may maximize the merchant's potential profit on the sale of the 42 inch plasma televisions. For example, the merchant may view data related to user desire for 42 inch plasma televisions to find that 10 users would be willing to by one for $1,000, 20 users would be willing to buy one for $975, and 1000 users would be willing to buy one for $899. The merchant may then user this information to assess the demand for the product in substantially real time (e.g., in real time) and then direct offers to the users who currently desire the product at a specified price. For example, if the merchant wishes to sell fifteen 42 inch plasma televisions, the merchant may set the price at $1,000 in order to maximize profits. If, however, the merchant wishes to sell 500 televisions, the merchant may set the price of the offers to $899 in order to ensure that the merchant sells the full inventory.

### Alternative Embodiments

Alternative embodiments of the system may comprise features that are, in some respects, similar to the various components described above. Selected distinguishing features of these alternative embodiments are discussed below.

User Shopping Preference Notification to Merchants

In various embodiments, the system is adapted to provide user shopping preferences to merchants such as particular items that users are seeking at particular prices. Merchants may then tailor offers to particular user shopping preferences in order to drive business. For example, if many users have shopping preferences that include finding reduced price Blu-ray players, a merchant may choose to make offers that include reduced price Blu-ray players. In particular embodiments, the system is adapted to allow merchants to direct particular offers to particular users. For example, a merchant may offer a Blu-ray player at a reduced price only to those users who had a shopping preference of finding a reduced price Blu-ray player.

In particular embodiments, the system may display a demand chart (e.g., such as a bar or line graph) that includes consumer demand data viewable by merchants. This demand chart may include, for example, the number of users that have expressed an interest at a particular item at various price points, current inventory that the merchant holds of the particular item, the current selling price of the particular item, the current cost of the particular item, whether the merchant has offered recent promotions on the item, or any other information related to consumer demand or the particular item itself. In various embodiments, the merchant can direct an offer only to those customers that have expressed a willingness to purchase a product at a particular price point and above.

Broad User Preferences

In various embodiments, the system is adapted to accept broadly defined user shopping preferences. In such embodiments, users may define a preference for a generic item or category of items that they wish to purchase at a certain discount level generally. For example, a user may define a broad user shopping preference of wanting a black dress shoe that is usually priced at $100 or more for $60. Such a user shopping preference may not include any specific mention of a particular brand of shoe or a particular store from which the user would like to purchase the shoe. In this example, if a merchant were offering a black wingtip oxford shoe that was normally priced at $129 for $59, the user who defined a shopping preference of wanting a black dress shoe that is usually priced at $100 or more for $60 would receive the offer.

Merchant Advertising Costs

In various embodiments, the cost of advertising for a merchant varies with how many times one of their advertisements was offered to a customer. For example, if a merchant offers a 42 inch television for $500, and such an offer meets the shopping requirements of 50 users, the merchant would pay for advertising to 50 users.

Automatic Offer Acceptance

In particular embodiments, the system is adapted to allow a user to select to have the system substantially automatically (e.g., automatically) complete a transaction between the user and a merchant when the merchant makes an offer that meets a particular one of the user's shopping preferences. For example, if a user has a shopping preference to purchase a 42 inch plasma television for $479, the system may be adapted to automatically complete a transaction between the user and a merchant who elects to offer the 42 inch plasma television for $479 or less. In particular embodiments, the system requires the user to enter billing information (e.g., credit card information or bank account information) into the system in order to facilitate the automatic transaction. In various embodiments, the merchant ships the item directly to the user as part of the automatic transaction. In other embodiments, the merchant makes the item available to the user to pick up at a physical location associated with the merchant (e.g., a store or warehouse located near the user's location).

User Preferences for Services

In particular embodiments, the system may be adapted to receive user preferences for services as well as products. A user, for example, may enter a preference to have their car detailed for less than $80 or to have the oil changed in their car for less than $15. In various embodiments, users may enter preferences for services such as legal or maid services. A user may enter a preference to receive, for example, maid cleaning services for less than $50 per hour.

Individual Directed Advertising

In various embodiments, the system is adapted to allow a merchant to direct an advertisement at a particular user. If a user, for example, has entered a user shopping preference of purchasing a particular model of laptop computer for $750 or less, a merchant may choose to offer the laptop computer to that user at $750 but not to make that offer to any other user. In particular embodiments, the $750 price for the laptop may only be available to that particular user, rather than being available as a general offer. A person other than the user wishing to purchase the same model of laptop computer may not be able to purchase the laptop for $750; the person other than the user may still have to pay the regular price for the laptop.

Shopping Lists

In particular embodiments, users can create shopping lists of items the user wishes to purchase along with prices at which the user wishes to purchase those items. The user may, for example, create a shopping list for each individual store from which the user has received advertisements. For example, the user may have an electronics shopping list that compiles items the user wishes to purchase from an electronics store (e.g., an iPhone for $150, a 42 inch plasma television for $499, and noise cancelling head phones for $80). In various embodiments, the system is configured to substantially automatically detect when the user makes a purchase of an advertised item in order to remove the item that has been purchased from the shopping list.

### CONCLUSION

Many modifications and other embodiments of the invention will come to mind to one skilled in the art to which this invention pertains having the benefit of the teachings presented in the foregoing descriptions and the associated drawings. While examples discussed above cover the use of the invention in the context advertising, the invention may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A non-transitory computer-readable medium storing computer-executable instructions for:
(A) receiving, from one or more users, at least one desired product or service and at least one desired price associated with said at least one desired product or service;
(B) displaying said at least one desired product or service and said at least one desired price associated with said at least one desired product or service to one or more merchants;
(C) receiving an offer for said particular product or service from said one or more merchants, said offer comprising one or more criteria and an one or more offer prices;
(D) receiving user information associated with said one or more users;
(E) determining which of said at least one desired prices are greater than or equal to said one or more offer prices;
(F) determining, based at least in part on said user information, which of said one or more users meet said one or more criteria; and
(G) at least partially in response to determining which of said at least one desired prices are at least said one or more offer price and which of said one or more users meets said one or more criteria, directing an offer for said particular product or service at said offer price to each of said one or more users associated with said at least one desired price that meet said one or more criteria, wherein:
said one or more offer prices is based at least in part on said at least one desired price and said user information.

2. (canceled)

3. The computer-readable medium of claim 1, further storing computer-executable instructions for:
(f) at least partially in response to determining which of said at least one desired prices are at least said one or more offer prices and which of said one or more users meet said one or more criteria, automatically completing a transaction between said one or more merchants and each of said one or more users associated with said at least one desired price that meet said one or more criteria, wherein said transaction includes a purchase of said at least one product or service at said offer price by said one or more users from said one or more merchants.

4-20. (canceled)

21. The computer-readable medium of claim 1, wherein said user information comprises:
(a) an age of said one or more users;
(b) a gender of said one or more users;
(c) an occupation of said one or more users; and
(d) a geographic location associated with said one or more users.

22. The computer-readable medium of claim 22, wherein said one or more criteria is selected from a group consisting of:
(a) an age range of said one or more users;
(b) said gender of said one or more users;
(c) said occupation of said one or more users; and
(d) said geographic location associated with said one or more users.

23. A computer system comprising:
at least one processor, wherein said computer system is configured for:
(A) enabling one or more users to create one or more shopping lists, said one or more shopping lists being associated with said one or more users and comprising:
one or more desired products or services; and
one or more desired prices associated with said one or more desired products or services;
(B) receiving user information associated with said one or more users;
(C) providing said one or more shopping lists and said user information to one or more merchants;
(D) receiving, from said one or more merchants, an offer for one or more offered products or services, said offer comprising:
an offer price; and
one or more criteria;
(E) determining whether said one or more desired products or services include said one or more offered products or services;
(F) determining whether said one or more desired prices are greater than or equal to said offer price;
(G) determining, based at least in part on said user information, whether said one or more users meet said one or more criteria; and
(H) at least partially in response to determining that said one or more desired products or services include said one or more offered products or services, said one or more desired prices are greater than or equal to said offer price, and said one or more users meet said one or more criteria, providing said offer to said one or more users.

24. The computer system of claim 23, wherein:
said offer is based at least in part on said one or more shopping lists and said user information.

25. The computer system of claim 24, wherein:
said user information comprises an age of said one or more users;
said criteria comprise a maximum age and a minimum age; and
determining whether said one or more users meet said one or more criteria comprises determining whether said age of said one or more users is an age between said maximum age and said minimum age.

26. The computer system of claim 24, wherein:
said user information comprises a substantially current location of said one or more users;
said criteria comprise a particular geographic area; and
determining whether said one or more users meet said one or more criteria comprises determining whether said current location of said one or more users is within said particular geographic area.

27. The computer system of claim 24, wherein:
said user information comprises a location of a residence associated with said one or more users;
said criteria comprise a particular geographic area; and
determining whether said one or more users meet said one or more criteria comprises determining whether said location of said residence associated with said one or more users is within said particular geographic area.

28. The computer system of claim 24, wherein:
said user information comprises a number of times said one or more users has shopped with said one or more merchants;
said computer system is further configured for determining, for said one or more users, a loyalty factor based at least in part on said number of times said one or more users has shopped with said one or more merchants,
said criteria comprise a minimum particular loyalty factor; and
determining whether said one or more users meet said one or more criteria comprises determining whether said loyalty factor associated with said one or more users is at least said minimum particular loyalty factor.

29. The computer system of claim 24, wherein said computer system is further configured for:
(F) at least partially in response to determining that said one or more desired products or services include said one or more offered products or services, said one or more desired prices are greater than or equal to said offer price, and said one or more users meet said one or more criteria, substantially automatically completing a transaction between said one or more users and said one or more merchants for said one or more offered products or services at said offered price.

30. The computer system of claim 29, wherein said computer system is further configured for:
(G) at least partially in response to completing said transaction, updating said one or more shopping lists to remove said one or more offered products or services.

31. The computer system of claim 24, wherein said computer system is further configured for:
(F) detecting that said one or more users has completed a purchase of said one or more offered products or services; and
(G) at least partially in response to detecting said purchase, updating said one or more shopping lists to remove said one or more offered products or services.

32. The computer system of claim 24, wherein said offer comprises a time period for which said offer is available to said one or more users.

33. The computer system of claim 24, wherein said computer system is further configured for:
(F) receiving, from said one or more users, a selection of one or more particular merchants, said one or more particular merchants being particular merchants from which said one or more users wish to receive offers;
(G) determining whether said one or more particular merchants include said one or more merchants; and
(H) at least partially in response to determining that said one or more particular merchants include said one or more merchants, providing said offer to said one or more users.

34. The computer system of claim 24, wherein said enabling said one or more users to create said one or more shopping lists comprises enabling said one or more users to create said one or more shopping lists using voice recognition.

35. A non-transitory computer-readable medium storing computer-executable instructions for:
(A) receiving user information associated with one or more users, said user information comprising:
an age of said one or more users;
a gender of said one or more users; and
a geographic location associated with said one or more users;
(B) receiving, from said one or more users, one or more shopping lists comprising:
one or more desired products or services associated with said one or more users; and
one or more desired prices associated with said one or more desired products or services;
(C) providing, to one or more merchants:
said user information;
said one or more shopping lists;
said one or more desired products or services associated with said user; and
said one or more desired prices associated with said one or more desired products or services;
(D) enabling said one or more merchants to direct one or more offers to one or more desired offer recipients, wherein:
said one or more desired offer recipients comprise said one or more users that meet on one or more offer recipient criteria, wherein:
said one or more offer recipient criteria are based at least in part on said user information; and
said one or more offer recipient criteria comprise a criteria for said geographic location associated with said one or more users to be within a particular distance of said one or more merchants;
said one or more offers comprise:
one or more offered products or services; and
one or more offered prices.

36. (canceled)

37. The non-transitory computer-readable medium of claim 35, wherein:
said user information comprises a number of times said one or more users has shopped with said one or more merchants;
said one or more offer recipient criteria comprise a minimum number of times a potential offer recipient has shopped with said one or more merchants; and
said one or more desired offer recipients comprise said one or more users that meet said offer recipient criteria.
